(19) United States
(12) Patent Application Publication
(10) Pub. No.: US 2017/0184721 A1
(43) Pub. Date: Jun. 29, 2017

(54) INDIRECT DISTANCE MEASUREMENT METHODS AND APPARATUS

(71) Applicant: Laurel At Sunset, Inc., Chatsworth, CA (US)

(72) Inventors: Jun Sun, Chatsworth, CA (US); Chen Shengpeng, Shanghai (CN)

(21) Appl. No.: 15/234,749

(22) Filed: Aug. 11, 2016

Related U.S. Application Data
(60) Provisional application No. 62/387,509, filed on Dec. 24, 2015.

(51) Int. Cl. G01S 17/02; G01S 7/481; G01S 7/486; G01S 17/10; G01S 7/51

(52) U.S. Cl. CPC G01S 17/023; G01S 17/10; G01S 7/51; G01S 7/486; G01S 7/4813

(57) ABSTRACT

A system, method, and apparatus for determining indirect distances are disclosed. An example apparatus includes a case including a laser device configured to determine a distance to a point at which a laser beam reflects off of an object. The example apparatus also comprises a client device that includes a processor configured to receive a first distance to a first point on the object and a second distance to a second point on the object. The processor is also configured to receive first and second angular movement data from a gyroscope and determine linear movement data from an accelerometer. The example processor determines, as an indirect measurement, a distance between the first point and the second point on the object using the first distance, the second distance, the first angular movement data, the second angular movement data, and the acceleration data.

### PRIORITY CLAIM

The present application is a continuation of, claims priority to and the benefit of U.S. Provisional Application Ser. No. 62/387,509, filed on Dec. 24, 2015, the entirety of which is incorporated herein by reference.

### BACKGROUND

James, an interior designer, was at the house of one of his clients. The client had hired James to update a dated living room and dining room. For any interior designer, the first step (after securing the business of a client) is evaluating the space to determine how the client's dreams can be realized while complimenting the other rooms and overall themes of the residence. Part of this process includes determining room dimensions and distances between (or sizes of) certain features or furniture. Interior designers use dimensions to construct a room layout to determine how different arrangements of furniture, custom millwork, and decorations will potentially look.

Today, James had a difficult task. The living room had a pentagonal shape, with two walls of windows overlooking the Pacific Ocean and two walls with entry ways. In addition, one of the walls had fireplace with an oversized mantel and stonework that extended to the ceiling. The dining room had a more traditional square shape but had columns of custom built-in cabinets interspaced between entry ways into three different rooms. Luckily, James had a handheld laser distance measurer and was able to quickly obtain room measurements. Within a few days, James was able to create layouts of the rooms and select furniture and decorations that seemed to fit. Due to the demands of the client and the dimensions of the rooms, most of the furniture and window covers had to be custom created. After showing the client renderings of the rooms, James received approval and placed the order.

Within a few months, the furniture and decorations arrived. James had everything installed. Within a few days, James received a call from the client. Expecting to hear words of praise, James was deeply disappointed to hear the client was very upset. The furniture didn't seem to match exactly as the renderings had shown. In some places, the furniture was slightly larger than the client expected, making the rooms feel smaller. In other places, paintings and wall decorations were smaller than expected, leaving more wall space between cabinets, entryways, and windows. Perplexed, James went to the client's house to confirm the size of the furniture and decorations. After confirming everything was sized as ordered, James took in the room. He could sense there was something off-balance. Confused, James grabbed his handheld laser distance measurer to confirm the room dimensions. To his astonishment, most of the dimensions had changed slightly by as much as four or five inches. While a few inches may not seem like a lot, in interior design a few inches can be the difference between a room feeling completely in balance and harmony (e.g., feng shui) and feeling disjoint and uncomfortable. In construction, the difference between a few inches can dictate whether a project meets a specification or code or whether a penalty has to be paid.

The problem experienced by James is, unfortunately, all too common. Known laser distance measurers are designed to determine direct and indirect distances using a laser beam. To determine a direct distance, a user points the laser distance measurer to a point on a wall (or other feature). The measurer uses a reflection of the laser from the point on the wall to calculate a direct distance to the point. To determine an indirect distance, a user points the laser distance measurer separately towards two different points to obtain a distance from the measurer to each point. The laser distance measurer then uses a difference between the two distances to determine a distance between the points.

One drawback of known laser distance measurers is that they require the first point to be at a right-angle from the user. Then, knowing there is a 90° difference between the two points, known laser distance measurers use the Pythagorean theorem (knowing the distance to each of the points (i.e., the hypotenuse and one of the legs)) to determine indirectly the distance between the points. Some users are unaware of this requirement. As a result, a user may not point a known laser distance measurer at a right-angle (or be able to precisely point the laser at a right-angle), while the measurer itself performs the distance calculation as though the first point is at a right-angle. The result, as James experienced, is that the distance between the two points is inaccurate.

Some known laser distance measurers indirectly measure the distance between two points that are not at right-angles to a user. However, these measurers still require the user to take at least one measurement of an intermediate point at a right-angle to determine an indirect distance to each end point. The measurers then add the two indirect distances together to get a total indirect distance between the two points. The drawback of these known measurers, as mentioned above, is that at least one right-angle measurement still has to be taken.

Another known drawback of known laser distance measurers is that they are programmed to assume a user is performing an indirect measurement from the exact same reference point. However, this requires the use of a tripod, which can be impractical or burdensome to use (especially in small spaces) if tens or hundreds of measurements have to be performed. In everyday use, a user typically moves or rotates a laser distance measurer when moving between a first point and a second point. Such movement is natural and almost impossible for a user to avoid. This movement, though, results in further inaccuracies in the calculation of the indirect distance, as James unfortunately discovered.

### SUMMARY

The present disclosure provides a new and innovative system, method, and apparatus for indirectly measuring a distance between two points on a wall or other object. In particular, the example system, method, and apparatus are configured to use laser distance data in conjunction with acceleration data and inertial data to determine a distance between two remote points. The acceleration data and inertial data provide six degree of freedom (“6 DoF”) movement information regarding how a laser measurement device moves while determining distances to remote points. The movement information may be used to compensate for unintentional or intentional user movement that would otherwise not be taken into account by known laser distance measurers. The example system, method, and apparatus disclosed herein accordingly provide more accurate and precise indirect distance calculations without requiring a user to measure one point at a right angle or use a tripod.

In an example embodiment, an indirect distance measurement apparatus includes a laser device configured to emit a laser beam, and detect a distance to a point at which the laser beam reflects off of an object. The indirect distance measurement apparatus also includes an accelerometer configured to measure linear movement of the apparatus and a gyroscope configured to measure angular movement (or an angular position) of the apparatus. The indirect distance measurement apparatus further includes a distance processor configured to transmit a first message, at a first time, instructing the laser device to perform a first direct distance measurement to determine a first distance to a first point on the object and receive, at the first time, first angular movement data from the gyroscope. The distance processor is also configured to receive, after the first time and before a second time, linear movement data from the accelerometer. The distance processor further transmits a second message, at the second time, instructing the laser device to perform a second direct distance measurement to determine a second distance to a second point on the object, and receive, at the second time, second angular movement data from the gyroscope. The example distance processor determines a distance between the first point and the second point on the object, as an indirect distance measurement, based on (i) the first distance, (ii), the second distance, (iii) the first angular movement data, (iv) the second angular movement data, and (v) the acceleration data. The distance processor may then transmit the determined distance between the first point and the second point.

In another embodiment, a distance measurement apparatus includes a case connected to a laser device having a light source configured to emit a laser beam and a processor configured to determine a distance to a point at which the laser beam reflects off of an object. The distance measurement apparatus also includes a client device communicatively coupled to the laser device. The client device includes an accelerometer configured to measure linear movement of the apparatus and a gyroscope configured to measure angular movement of the apparatus. The client device also includes a processor configured to receive, at a first time from the laser device, a first distance to a first point on the object, and at the second time from the laser device, a second distance to a second point on the object. The processor is further configured to determine, at the first time, first angular movement data from the gyroscope and at the second time, second angular movement data from the gyroscope. Moreover, the processor is configured to determine, between the first time and a second time, linear movement data from the accelerometer, and determine a distance between the first point and the second point on the object using (i) the first distance, (ii), the second distance, (iii) the first angular movement data, (iv) the second angular movement data, and (v) the acceleration data. The client device additionally includes a display screen configured to display the determined distance between the first point and the second point.

Additional features and advantages of the disclosed system, method, and apparatus are described in, and will be apparent from, the following Detailed Description and the Figures.

### BRIEF DESCRIPTION OF THE FIGURES

FIG. 1 shows a diagram of angular movement data detected by one or more gyroscopes in a client device (e.g., a smartphone or tablet computer), according to an example embodiment of the present disclosure.

FIG. 2 shows a diagram of linear movement data detected by one or more accelerometers in the client device of FIG. 1, according to an example embodiment of the present disclosure.

FIGS. 3 to 5 show diagrams of an example laser distance device including the client device of FIGS. 1 and 2 and a laser distance measurer, according to example embodiments of the present disclosure.

FIGS. 6 to 8 show diagrams illustrative of using the example laser distance device of FIGS. 3 to 5 to measure direct and indirect distances, according to an example embodiment of the present disclosure.

FIG. 9 shows a diagram of components of the example laser distance device of FIG. 3, according to an example embodiment of the present disclosure.

FIG. 10 shows a diagram that graphically illustrates an operation of example routines and/or algorithms operated by example laser distance device of FIG. 3 to calculate an indirect distance, according to an example embodiment of the present disclosure.

FIG. 11 shows a data structure or file of data recorded by the example laser distance device of FIG. 3 to determine an indirect distance between two points, according to an example embodiment of the present disclosure.

FIG. 12 shows a diagram of an example project file that includes distance measurements for a project determined by the example laser distance device of FIG. 3, according to an example embodiment of the present disclosure.

FIG. 13 shows a diagram of an example image created by the example laser distance device of FIG. 3, according to an example embodiment of the present disclosure.

FIG. 14 shows a diagram of an example user interface of an application provided by the example laser distance device of FIG. 3, according to an example embodiment of the present disclosure.

FIG. 15 illustrates flow diagrams showing example procedures to determine a dock state of the laser distance measurer of FIG. 3, according to an example embodiment of the present disclosure.

FIGS. 16 and 17 illustrate flow diagrams showing example procedures to determine an indirect distance between two remote points, according to example embodiments of the present disclosure.

### DETAILED DESCRIPTION

The present disclosure relates in general to a method, apparatus, and system for determining a distance indirectly between two remote points on a wall or other object. In particular, the example method, apparatus, and system disclosed herein are configured to determine an indirect distance between two remote points using data from motion sensors (e.g., accelerometers and gyroscopes) to compensate for intended or unintended user movement of a laser distance device. Such compensation adjusts for any linear and/or angular movement experienced by the laser distance device while acquiring the distance between two remote points. The data from the motion sensors is also used to determine an angle between the two points (or three-dimensional coordinates of the two points), which enables the indirect distance to be determined without the first point being measured at a right angle. As disclosed below, the example method, apparatus, and system disclosed uses the motion data with one or more trigonometric functions, algorithms, or routines to determine an indirect distance between two remote points.

In an example, the method apparatus, and system disclosed herein are embodied within a laser distance measurer that is physically and communicatively coupled to a smartphone or tablet computer. The example laser distance measurer is configured to determine a direct distance to a remote point on a wall or other object of interest. The laser distance measurer transmits the determined distance to the smartphone or tablet computer. In addition, the smartphone or tablet computer acquires motion data from one or more internal accelerometers and/or gyroscopes. The smartphone and/or tablet computer includes an application (e.g., an ‘app’) that is configured to apply one or more trigonometric routines, algorithms, and/or functions to the measured direct distances and the acquired motion data to determine indirectly the distance between the two remote points. The application operating on the smartphone and/or tablet computer is configured to display the indirect and/or direct distance measurements and enable a user to store the distances to a project file.

In some examples, the smartphone and/or laser distance measurer includes a camera configured to record an image related to distance measurements. For instance, the camera may record (upon instruction from a user) an image of a wall in which distance measurements were made. In some embodiments, the smartphone may record an image while a direct distance measurement is being performed such than an image of a laser beam incident on the wall (or other object) appears in the image. In other embodiments, an image is recorded for each direct distance measurement and combined to visually illustrate the two remote points in one image or a composite image. The application is configured to store the image in relation to the distance measurements so that a distance measured between two points is visible within the image.

Additionally, in some examples, the smartphone and/or laser distance measurer is configured to determine a dock state. For instance, the laser distance measurer may include one or more motion sensors. The application operating on the smartphone or tablet computer is configured to compare the motion data from internal motion sensors to motion data from the motion sensors within the laser distance measurer. The application may determine that the laser distance measurer is undocked from the smartphone if the comparison indicates that a threshold number (e.g., 50%, 65%, 75%, 85%, 90%, etc.) of data points (collected over 1 second, 2 seconds, etc.) do not match or are not substantially similar (e.g., within 10%, 20%, etc. in value). After detecting that the laser distance measurer is undocked, the application may disable functionality to directly measure distances, cause an alert message to be displayed, instruct the measurer to power off, terminate communication with the measurer, and/or disregard distance measurement data from the measurer.

The example method, apparatus, and system disclosed herein overcome many limitations of known laser distance measurers by using 6 DoF movement information or motion data to determine a spatial position and/or orientation of the example laser distance device itself. Any movement of the laser distance device is detected and used to adjust, recalculate, or refine the indirect measurement. The 6 DoF movement information also enables an angle to be determined between the two remote points, which eliminates the need of making the first direct measurement at a right angle. It should be appreciated that the disclosed example laser distance device is significantly more than simply adding accelerometers and/or gyroscopes to known laser distance measurers. The example laser distance device includes instructions, algorithms, and/or routines for processing movement information from the motion sensors into 6 DoF components, which are used within one or more trigonometric functions to determine an indirect distance between two remote points by, for example, determining an angle between two remote points, adjusting a distance to a second point to account for movement during the measurement, and/or determining coordinates of the remote points. In contrast, known laser distance measurers instead are configured to determine an indirect distance between two remote points assuming the first point is recorded at a right angle. Further, the two points must be exactly vertically aligned.

The example method, apparatus, and system disclosed herein overcome limitations of known laser distance measurers through the use of acceleration and/or inertial movement information or motion data. The use of this movement information enables an example laser distance device to determine relatively accurate and precise indirect distances between two points while being used in a user's hand. The use of the movement information provides a user the freedom to use the example laser distance device is more dynamic configurations, where for example, a tripod may be too cumbersome or measuring at right angles is not possible or inconvenient. The use of the movement information also enables a user to record distances more quickly using a point-and-shoot approach rather than ensuring points are precisely aligned at right angles (or vertically aligned).

In some instances, the example method, apparatus, and system disclosed herein provide indirect distance measurements that have a margin of error that is between zero and five centimeters. By comparison, known distance measurers have published margins of error greater than five centimeters. Further, the example method, apparatus, and system disclosed herein enable an indirect distance to be determined in any direction, while known distance measurers may only support horizontal indirect measurements. Moreover, the 6 DOF movement information enables the disclosed laser distance device to be used as a 2-axis level, while known laser distance measurers may only provide a single-axis level.

Reference is made throughout to direct distances and indirect distances. As disclosed herein, a direct distance corresponds to a distance measurement performed by a laser distance measurer between the measurer itself and an incident point on a wall (or other object). The incident point of the laser beam is referred to herein as a remote point, given that the incident point is remote from the laser distance measurer. The direct distance is accordingly a distance from the laser distance measurer to an incident point on a wall. In contrast, an indirect distance corresponds to a calculation of a distance between two known remote or laser incident points. In many instances, the indirect distance provides more useful information than the direct distance because the direct distance is based on a point of reference from a user (or relative to the location of the user), which may not include any particular feature or room element being measured.

Reference is also made herein to measuring a distance to a point on an object. Examples disclosed herein refer to objects as walls. However, objects may include other construction or interior design features such as, for example, windows, doors, cabinets, entryways, openings, pictures, furniture, support columns/beams, fireplaces, rugs, pipes, boards, and custom millwork. It should be appreciated that the example laser distance device disclosed herein is configured to measure indirectly a distance between any two points detectable by a laser detector and/or camera.

Further, while reference is made to using a laser (or other light) to determine a direct distance, it should be appreciated that other devices may be used to determine a direct distance to a remote point. For example, images recorded by multiple cameras and combined into a stereo imagine can be used to determine depth data related to a point on an object. In another example, near-infrared LEDs may be used to determine depth data from an image recorded by a single camera. In yet other embodiments, acoustics or specifically trimmed sound waves may be used to determine a distance to a point.

Reference is further made throughout to movement information or motion data. As disclosed herein, movement information or motion data is data from motion sensors including, for example, an accelerometer and/or a gyroscope. Data from an accelerometer is referred to herein as linear movement data and is indicative of linear or straight-line movement along an axis. Data from a gyroscope is referred to herein as inertial or angular movement data and is indicative of angular velocity or angular acceleration.

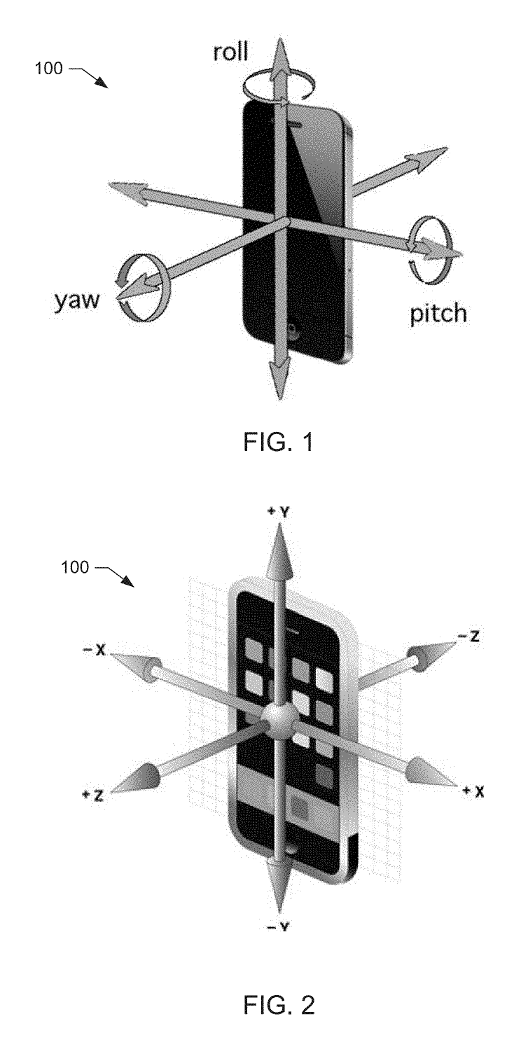

FIG. 1 shows a diagram of angular movement data detected by one or more gyroscopes in a client device 100 (e.g., a smartphone or tablet computer). The angular movement data includes rotational movement data along a yaw-axis, a roll-axis, and a pitch-axis. Processing of the angular movement data enables an orientation or position of the client device 100 to be determined. For example, rotation around the pitch-axis is indicative of how much the client device 100 has been tilted up or down while rotation around the roll-axis is indicative of how much the client device 100 has been tilted left or right. The client device 100 may include a single gyroscope to measure angular movement around each respective axis. In other embodiments, the client device 100 may include a dual-axis gyroscope configured to measure angular movement around two axes (e.g., yaw and pitch) and a third gyroscope orthogonal to the dual-axis gyroscope configured to measure angular movement around the third axis (e.g., the roll-axis). The dual-axis gyroscope may include, for example, a microelectromechanical system (“MEMS”) comb-drive resonator. In yet other embodiments, the gyroscope may include a tri-axis gyroscope or just a dual-axis gyroscope.

FIG. 2 shows a diagram of linear movement data detected by one or more accelerometers in the client device 100. The linear movement data includes movement along an x-axis, a y-axis, and a z-axis. The client device 100 may include one, two, or three single-axis accelerometers, a dual-axis accelerometer and a single-axis accelerometer, or a tri-axis accelerometer. Processing of the linear movement data enables a position and/or velocity of the client device 100 to be determined.

In some examples, the gyroscopes and accelerometers may be included within a single package as an inertial sensor. The combination of the gyroscopes and accelerometers provides, for example, 6 DoF movement detection. An application operating on the smartphone 100 may use the 6 DoF movement information to continuously calculate via dead reckoning a position, orientation, and/or velocity (e.g., direction and speed of movement) of the smartphone 100 (e.g., the laser distance device disclosed herein) without the need for external references. Further, an inertial sensor enables detection of acceleration in conjunction with inclination when the client device 100 is being tilted or shaken.

### Example Laser Distance Device

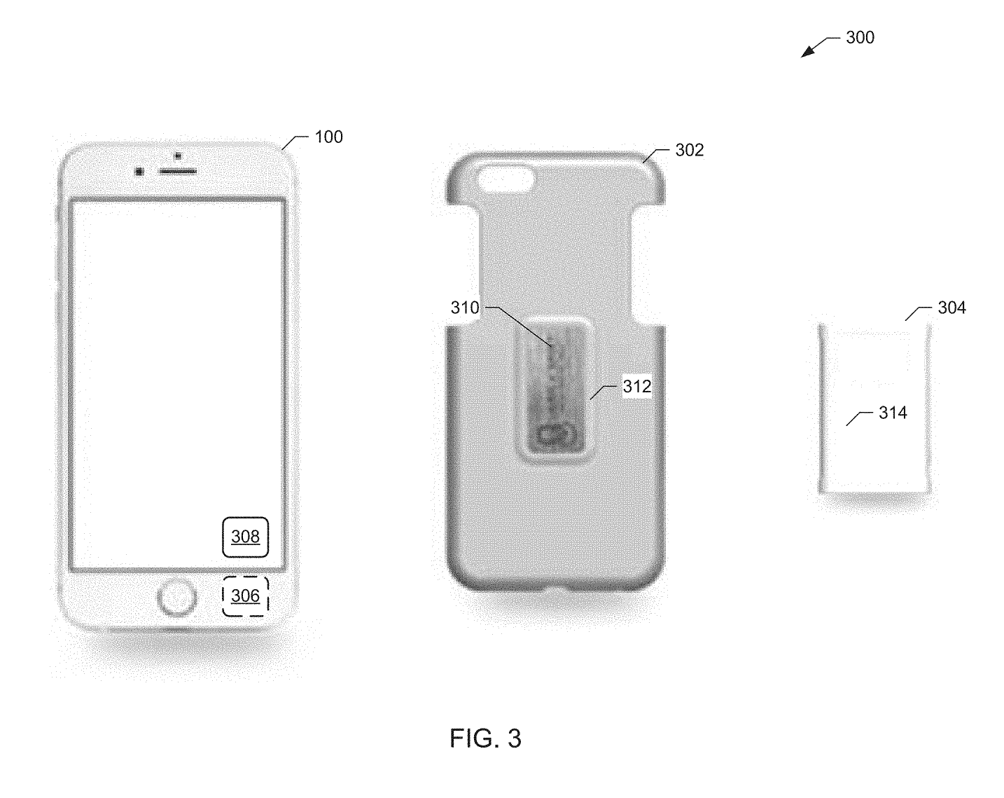

FIGS. 3 to 5 show diagrams of an example laser distance device 300, according to an example embodiment of the present disclosure. The laser distance device 300 includes a client device 100, a case 302, and a laser distance measurer 304. FIG. 3 shows a diagram of the client device 100, case 302, and laser distance measurer 304 disconnected.

The example client device 100 may include any cell phone, personal digital assistant, smartphone, tablet computer, laptop computer, smart-eyewear, smartwatch, etc. that includes (or is communicatively coupled to) one or more motion sensors 306. The client device 100 includes an application 308 configured to determine an indirect distance based on direct distances to two remote points and movement information detected by the motion sensors 306. The client device 100 includes an operating system for managing the operation of the application 308. The operating system may include, for example, iOS™, OSX™, Windows®, Android™, Linux™, or any modified version of an operating system such as those configured to operate on Raspberry Pi™ systems.

The example case 302 is configured to physically connect to the client device 100. The case 302 is configured to be removable from the client device 100. The case 302 includes a connector 310 configured to physically connect the case 302 to the laser distance measurer 304. As shown in FIG. 3, the connector 310 may include a magnet configured to connect to a magnet on the laser distance measurer 304. In other examples, the connector 310 may include a mechanical connection component including, for example, Velcro, snaps, locking-slots, etc. for connecting to a compatible component on the laser distance measurer 304.

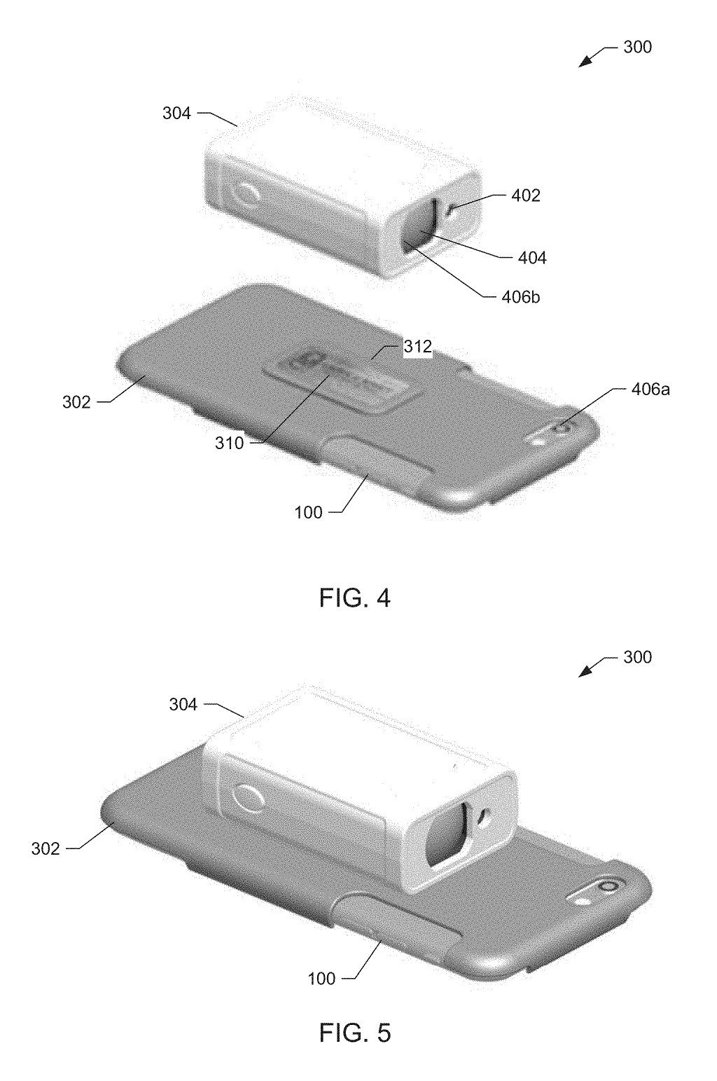

FIG. 4 shows a diagram of the case 302 connected to the client device 100 and FIG. 5 shows a diagram of the laser distance measurer 304 connected to the case 302. To help position the laser distance measurer 304 for connection, the case 302 includes an alignment tab 312. The example alignment tab 312 is configured to mate with a similar alignment grove 314 (or indentation) on the laser distance measurer 304 to ensure that the measurer 304 is properly aligned for direct distance measurements. The alignment tab 312 is also configured to prevent the laser distance measurer 304 from moving (with respect to the client device 100) during use. FIGS. 3 and 4 show the alignment tab 312 encircling the connector 310. However, in other embodiments, the alignment tab 312 may include a series or matrix of pegs or holes separate from or integrated with the connector 310 and configured to mate with corresponding structure on the laser distance measurer 304. The alignment tab 312 may also include one or more geometrically-shaped indentations or protrusions from the case 302 configured to pair with corresponding structure on the laser distance measurer 304.

With respect to alignment, in some instances, the application 308 may be configured based on an assumption that the laser distance measurer 304 transmits a laser beam in the +y-axis direction (shown in FIG. 2). Any misalignment or incorrect positioning of the laser distance measurer 304 with respect to the client device 100 may cause errors determining the indirect distance. In other instances, the application 308 may be configured to account for misalignment of the laser distance measurer 304. For example, the application 308 may normalize motion data with respect to motion data acquired when a distance to a first remote point is determined. Additionally or alternatively, the application 308 may determine the indirect distance based on differences between motion data at the time when the direct distances to the two remote points were determined such that any misalignment of the laser distance measurer 304 becomes immaterial. In other words, as long as the laser distance measurer 304 is aligned in the same position for both direct distance measurements, any misalignment with respect to the client device 100 is moot.

As mentioned above, the example laser distance measurer 304 is configured to measure direct distances to a point at which a laser beam is incident on a wall or other object. As shown in FIGS. 4 and 5, the laser distance measurer 304 includes a laser transmitter 402 and a laser detector 404. The laser transmitter 402 is configured to focus and transmit a laser beam (or other high-energy light) in a straight line. The laser detector 404 includes optics (including lenses and/or photo sensors) configured to detect a reflection of the laser beam from the incident point. A processor within the laser distance measurer 304 is configured to determine a time difference between when the laser is transmitted from the transmitter 402 and when the reflection of the laser from the incident point is detected by the detector 404. The time difference is indicative of the distance, with longer times corresponding to longer differences.

In some embodiments, the client device 100 and/or the laser distance measurer 304 includes a camera 406. For instance, the client device 100 of FIGS. 3 to 5 includes a camera 406a along a top edge while the laser distance measurer 304 includes a camera 406b adjacent to the laser detector 404. As discussed in more detail below, the camera 406 is configured to record images of objects being measured before, during, and/or after direct measurements are made.

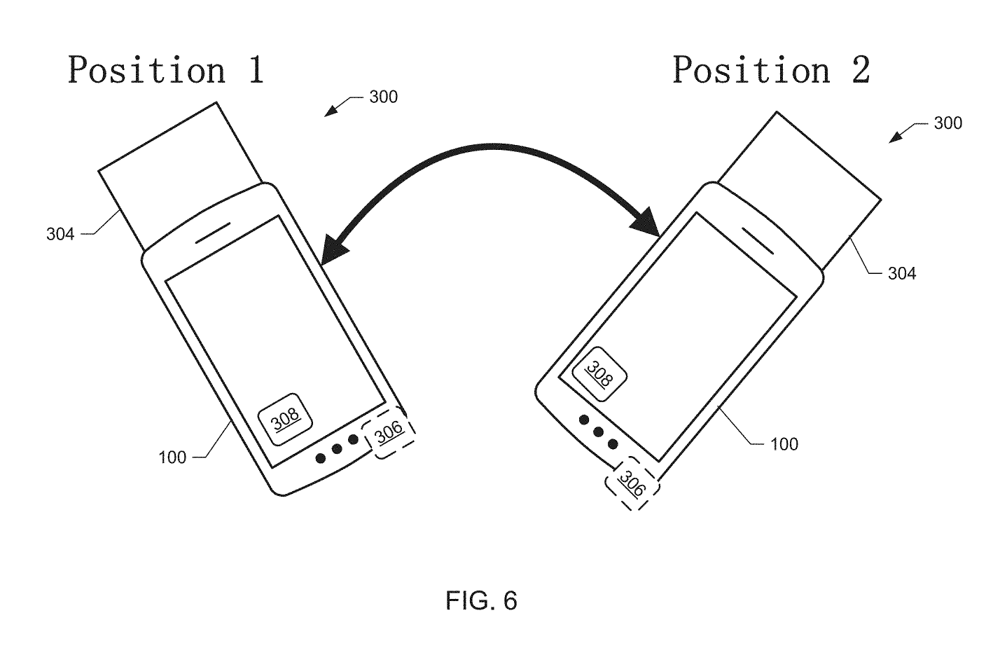

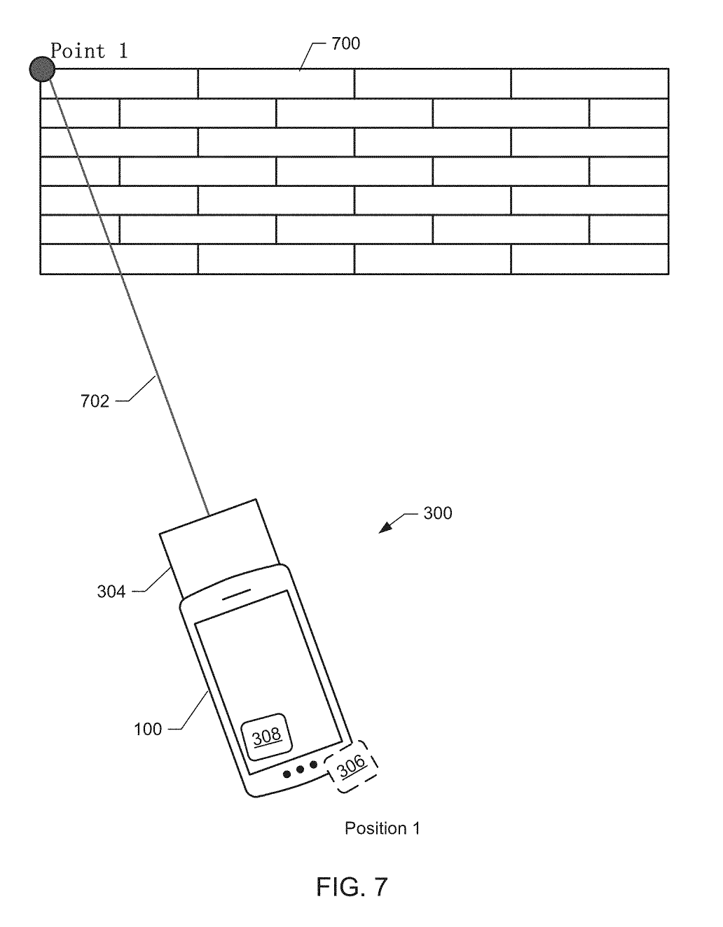

FIGS. 6 to 8 show diagrams illustrative of using the example laser distance device 300 of FIGS. 3 to 5 to measure distances, according to an example embodiment of the present disclosure. To acquire an indirect measurement between two points (i.e., Point 1 and Point 2) of an object 700, the laser distance device 300 is first pointed at Point 1, as shown in FIGS. 6 and 7. It should be noted that Point 1 is not at a right angle to the laser distance device 300. The application 308 is configured to receive an instruction from a user to perform a direct distance measurement to Point 1. After receiving the instruction, the application 308 causes the laser distance measurer 304 to transmit a laser beam 702, which becomes incident on the object 700 at Point 1. The laser distance measurer 304 determines a time for the laser beam to reflect back to detector 404 for determining the direct distance to Point 1. The measurer 304 transmits this distance to the application 308. At about the same time (e.g., within one or two seconds), the application 308 is configured to acquire movement information from the motion sensors 306 including angular movement data from gyroscopes and linear movement data from accelerometers. This movement information acquired at Position 1 is indicative of an orientation and position of the laser distance device 300.

As shown in FIG. 6, a user moves the laser distance device 300 to Position 2. Moving from Position 1 to Position 2 not only changes the angle at which the laser distance device 300 faces but also moves the device 300 in the +x-direction. It should be appreciated that in other embodiments, the laser distance device 300 may move in other directions such as the +/−z-direction, the −x-direction, and/or the +/−y-direction. During the movement from Position 1 to Position 2, the application 308 is configured to record movement information. At Position 2, the user provides an indication to the application 308 to record a direct distance measurement to Point 2. This instruction causes the application 308 to send one or more messages to the laser distance measurer 304 to transmit a laser beam 802 to Point 2, which is the portion of the object 700 at which the laser beam becomes incident. The laser distance measurer 304 determines the direct distance to Point 2 and transmits this distance data to the application 308. At about the same time, the application 308 is configured to acquire movement information from the motion sensors 306. At this point, the example application 308 is configured to determine the indirect distance from Point 1 to Point 2 taking into account the direct distance data, the movement data related to Point 1 and Point 2, and the movement data related to moving between Position 1 and Position 2.

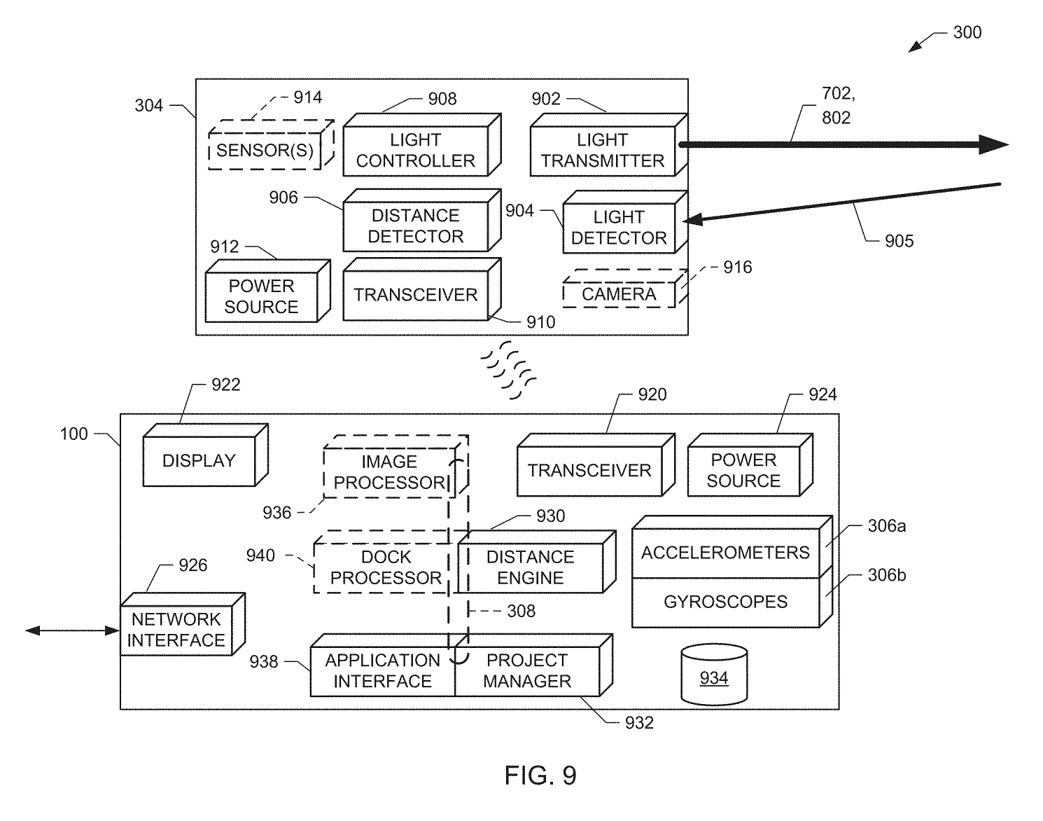

FIG. 9 shows a diagram of components of the laser distance device 300 of FIG. 3, according to an example embodiment of the present disclosure. As discussed above, the device 300 includes the laser distance measurer 304 and the smartphone 100. In some examples, as shown in FIGS. 3 to 5, the laser distance measurer 304 and the smartphone 100 are separate devices. However, in some embodiments, the laser distance measurer 304 and the smartphone 100 may be included within the same device, or at least the same housing or packaging. Thus, while FIG. 9 shows the laser distance measurer 304 communicatively coupled to the smartphone 100, in other embodiments at least some of the components of the laser distance measurer 304 may be integrated with the smartphone 100 or at least some of the components of the smartphone (e.g., display, motion sensors, and processors) may be integrated with the laser distance measurer 304.

### Laser Distance Measurer Embodiment

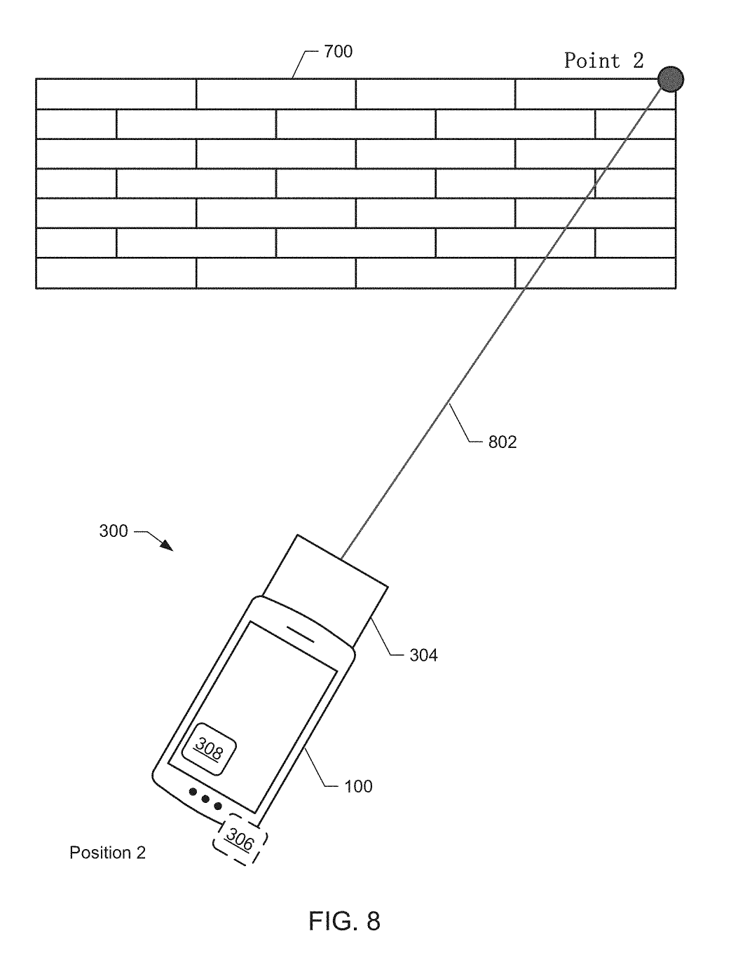

The example laser distance measurer 304 of FIG. 9 is configured to measure direct distances to points on a wall or other object. To measure direct distances, the example laser distance measurer 304 includes a light transmitter 902 and a light detector 904. The example light transmitter 902 configured to transmit one or more beams of light including, for example, the laser beams 702 and 802 of FIGS. 7 and 8. The light transmitter 902 includes any lenses, mirrors, etc. for condensing and focusing the light into a high-energy beam. The example light detector 904 is configured to detect a reflection 905 of the laser beam 702 and 802 from an incident point on a wall or other object. The light detector 904 includes, for example, photo sensors for sensing the reflected laser light. The light detector 904 also includes mirrors and/or lens for condensing the reflected light for improved detection.

The example laser distance measurer 304 includes a distance detector 906 and a light controller 908 to control the timing of laser transmission to determine direct distances. The example light controller 908 is configured to transmit one or more light control messages to the light transmitter 902 that cause the light transmitter 902 to transmit a laser beam for a specified period of time. The messages may include an instruction for the light transmitter 902 to turn the laser beam on or turn the laser beam off. The messages may also include an instruction indicating a duration that the light transmitter 902 is to transmit the laser beam. At the same time, the light controller 908 may also transmit one or more messages to the distance detector 906 to start a timer. The light controller 908 is configured to transmit the light control messages in response to receiving an instruction from the application 308 operating on the client device 100 indicative that a user wishes to determine a direct distance.

The example distance detector 906 is configured to determine a direct distance to an incident point based on a time for a transmitted laser beam to reflect back to the light detector 904. The distance detector 906 begins a timer after receiving one or more messages from the light controller 908 indicative that the light transmitter 902 is starting transmission of a laser beam. The distance detector 906 stops the timer upon receiving a message from the light detector 904 indicative of the reflected laser beam 905 being detected. The value of the timer is used by the distance detector 906 to determine the direct distance to an incident point of the laser beam (e.g., Point 1 and Point 2 of FIGS. 7 and 8). For instance, the value of the timer may be linearly proportional to the direct distance. It should be appreciated, given the speed of light, the reflection time for the laser beam is very short. Accordingly, in some embodiments, the distance detector 906 may receive electrical signals (used for operating the timer) from the light transmitter 902 and the light detector 904 indicative of when light is transmitted and received.

In some embodiments, the light transmitter 902 may transmit pulses or laser beams (which may appear as one continuous beam to a user) and provide indications of the time each pulse was transmitted. The distance detector 906 may operate a timer for each pulse, which are stopped when the light detector 904 senses the reflection of the respective pulses. In this embodiment, the distance detector 906 may average the determined direct distances for the multiple pulses.

The example laser distance measurer 304 of FIG. 9 also includes a transceiver 910 to communicate with the client device 100. The example transceiver 910 may be configured to facilitate wireless communication and/or wired communication. For instance, the transceiver 910 may be configured to receive and/or transmit messages in a format and frequency compatible with the Bluetooth® protocol, a near-field communication (“NFC”) protocol, the Wi-Fi® protocol, a Zigbee® protocol, a Z-wave® protocol, or any other RF protocol. The transceiver 910 may additionally or alternatively, support a physical universal serial bus (“USB”) connection or a Lightning™ connection.

The example transceiver 910 is configured to pair with the client device 100 using a pairing method compatible with the underlying communication protocol. The transceiver 910 is also configured to receive one or more messages from the application 308 on the client device 100 providing instructions to perform a direct distance measurement. The transceiver 910 converts the message into a format compatible to transmit through electrical traces or a wire to the light controller 910 to begin the measurement. The example transceiver 910 is also configured to convert one or more messages (including direct distance information) from the distance detector 906 into a format for transmitting to the client device 100.

The example laser distance measurer 304 of FIG. 9 further includes a power source 912, which may include a disposable or rechargeable battery. In other examples, the power source 912 may include one or more capacitors configured to store a change. The example power source 912 is configured to provide power to the light transmitter 902 to generate laser beams and the light detector 904 to detect laser beams. The power source 912 also provides power to the components 906, 908, and 910 for communication and processing of messages and/or determination of a direct distance. In some instances, the power source 912 may be charged inductively via the transceiver 910 with wireless RF power being received from a charging pad or the client device 100. For instance, the laser distance measurer 304 may receive enough power to operate only when connected to the client device 100. The power source 912 may also include a kinetic energy converter.

In some embodiments, the laser distance measurer 304 may include one or more motion sensors 914 and/or a camera 916. The example motion sensors 914 may include gyroscopes, accelerometers, proximity sensors, ambient light sensors, etc. The sensors 914 are configured to be used to determine a dock state of the laser distance measurer 304. For example, movement information from gyroscopes or accelerometers of the motion sensors 914 may be compared by the application 308 to movement information recorded by the client device 100. A match in movement data is indicative that the laser distance measurer 304 is connected to the client device 100 since both experience the same movement or orientation at the same time. Alternatively, proximity sensors or ambient light sensors may be used to detect physical proximity between the laser distance measurer 304 and the client device 100. For instance, a proximity sensor may sense when the laser distance measurer 304 is within a few millimeters of the client device 100. Movement data detected by the motion sensors 914 is transmitted to the client device 100 via the transceiver 910.

The example camera 916 is configured to record one or more images of an object from which direct distance measurements are made. In some embodiments, the light controller 908 may transmit one or more messages to the camera 916 at about the same time messages are sent to the light transmitter 902. This causes the camera 916 to record an image when the laser beam is incident on the object, causing an image of the incident light to be recorded. The camera 916 transmits the image to the transceiver 910 for transmission to the application 308 at the client device 100. In some instances, the distance detector 906 is configured to cause the image to be transmitted in conjunction with the direct distance measurement.

### Client Device Embodiment

The example client device 100 of FIG. 9 is configured to determine an indirect distance between two points. The client device 100 includes a transceiver 920 configured to communicatively couple to the transceiver 910 of the laser distance measurer 304. Similar to the transceiver 910, the transceiver 920 may be configured to receive and/or transmit messages in a format and frequency compatible with the Bluetooth® protocol, a NFC protocol, the Wi-Fi® protocol, a Zigbee® protocol, a Z-wave® protocol, or any other RF protocol. The transceiver 920 may additionally or alternatively, support a physical USB connection or a Lightning™ connection.

The example transceiver 920 is configured to format messages for performing a direct measurement for transmission to the transceiver 910. The transceiver 920 is also configured to convert messages received from the laser distance measurer 304 into a format compatible for processing by other components. In some embodiments, the transceiver 920 may queue messages in an internal temporary memory until bandwidth or downstream processing is available.

The client device 100 of FIG. 9 also includes one or more internal motion sensors including, for example, accelerometers 306a and gyroscopes 306b. The accelerometers 306a may include, for example, an LIS302DL 3-axis MEMS based accelerometer produced by STMicroelectronics® or an LIS331DL chip, also manufactured by STMicroelectronics®. The accelerometers 306a may be configured to operate in granular or precise modes including ±2 g and ±8 g with a sampling rate between 100 MHz to 400 MHz. The precise mode provides a resolution of about 0.018 g. The accelerometers 306a transmit linear movement data that includes a g-value, a normalized value indicative of a g-value, or a different value, such as meters per second squared (m/s²) or centimeters per second squared (cm/s²).

The gyroscopes 306b may include a L2G2IS, a L3GD2OH, an I3G4250D, or an A3G4250D 3-axis MEMS angular acceleration sensor produced by STMicroelectronics®, which provide a full-scale range from 30 to 6000 degrees per second (“°/s”) with a resolution of 0.01°/s. The gyroscopes 306b are configured to transmit angular movement data that includes a °/s value, a radians per second value, and/or a normalized value indicative of a °/s value.

The client device 100 further includes a display screen 922 and a power source 924. The display screen 922 is configured to present information related to the application 308 including distance values. The display screen 922 may include a touch-interface for receiving instructions or feedback from a user. The example power source 924 includes a rechargeable battery for powering the components of the client device 100. In some instances, the power source 924 may include kinetic energy harvesting devices to transduce sensed kinetic energy into power for recharging the battery. Further, in some instances, the power source 924 may be configured to provide power to the laser distance measurer 304 via the transceiver 920.

Moreover, the client device 100 includes a network interface 926 configured to connect to a cellular and/or Wi-Fi network. The network interface 926 is configured to transmit distance data and/or images to remote storage systems, such as cloud storage systems or a remote server configured to generate room renderings. The network interface 926 may be connected to remote servers via, for example, the Internet, a Wi-Fi network, a local area network, a 4G cellular network, a 5G cellular network, etc.

### I. Indirect Distance Determination Embodiments

The example client device 100 of FIG. 9 also includes a distance engine 930 configured to determine an indirect distance between two points. The distance engine 930 may be included as machine-readable instructions of the application 308 and/or operate as part of a microprocessor or microcontroller. The example distance engine 930 is configured to receive direct distance data from the laser distance measurer 304 in conjunction with movement data from the motion sensors 306 to calculate an indirect distance.

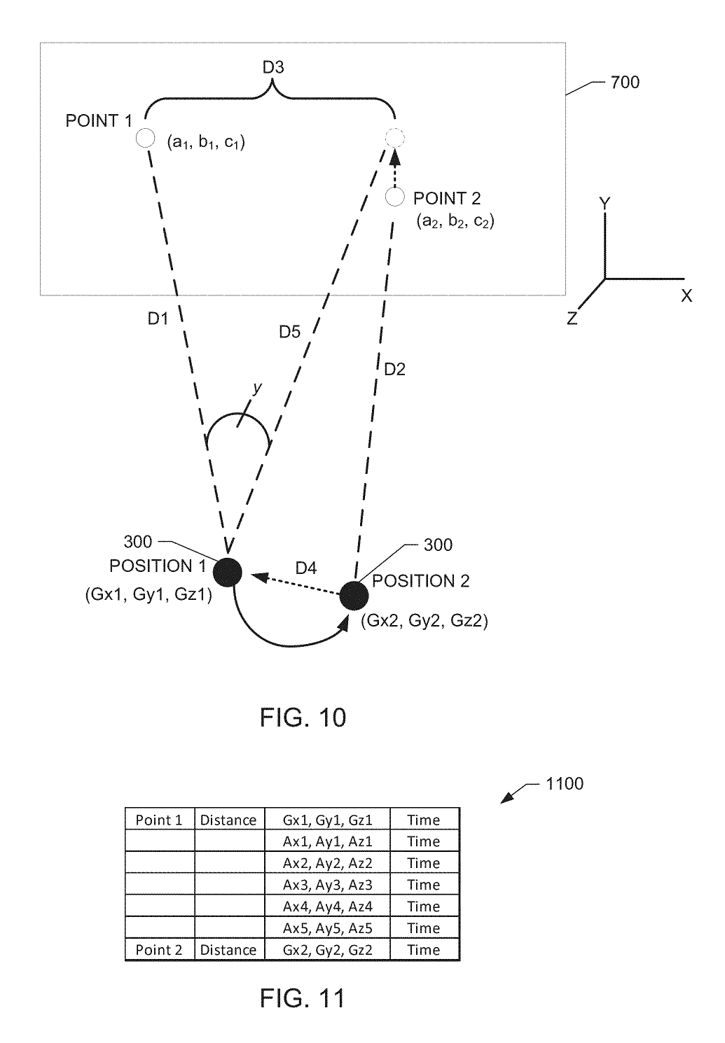

Operation of the distance engine 930 is explained with reference to FIGS. 10 and 11. FIG. 10 shows a diagram that graphically illustrates an operation of example routines and/or algorithms operated by the distance engine 930 to calculate an indirect distance, according to an example embodiment of the present disclosure. FIG. 11 shows a data structure or file 1100 of data recorded by the distance engine 930 to determine the indirect distance between two points, according to an example embodiment of the present disclosure.

The example distance engine 930 is configured to receive an indication from a user to perform a distance measurement while the user is located at Position 1. After the user has moved to Position 2, the distance engine 930 receives another indication to perform a distance measurement. For each received indication, the distance engine 930 is configured to transmit one or more messages to the laser distance measurer 304 via the transceiver 920 instructing that a distance measurement is to be performed. At about the same time (e.g., within two seconds), the distance engine 930 is configured to poll the motion sensors 306 for linear and angular acceleration movement data. Polling the sensors 306 may include recording (and/or averaging) movement data for a predetermined time period (e.g., one second).

The example distance engine 930 receives one or more messages from the laser distance measurer 304 after a direct distance to Point 1 of the object 700 is determined (shown in FIG. 10 as D1). The messages include, for example, a distance value of D1 in inches, feet, centimeters, meters, and/or yards. The distance engine 930 records the distance of Point 1 to the file 1100. The distance engine 930 also stores the angular movement data from the gyroscopes 306b to the file 1100 in the same row (i.e., Gx1, Gy1, Gz1). The stored angular movement data may include an average over a sample period or all data received over the sample period. Further, the angular movement data may be stored as radians/s, °/s, or a normalized value. Additionally or alternatively, the angular movement data may include a degree or radian of the client device 100 as determined from the radians/s, °/s, or normalized value received from the gyroscopes 306a. The degree or radian value is indicative of an orientation of the client device 100 based on the degree or radian value with respect to the roll, pitch, and yaw axes. The distance engine 930 also determines and stores to the file 1100 the time at which the distance to Point 1 was determined. The time may be an absolute time and/or a relative time that begins when the distance to Point 1 is determined.

The example distance engine 930 is configured to poll the accelerometers 306a for linear movement data. For example, as the user moves from Position 1 to Position 2, the distance engine 930 is configured to record (and store to the file 1100) linear movement data, which may include a g-value or a distance value calculated from the g-value with respect to an origin (e.g., Position 1). The linear movement data is stored to the file 1100 as Axn, Ayn, and Azn and includes the corresponding time in which the data was received. In some instances, the distance engine 930 is configured to determine linear movement along the x, y, and z axes by calculating linear distances from the acceleration g-values. The distance engine 930 may use the equations below to determine linear movement along the x, y, and z axes.

$$S ( {t}_{i} ) = s ( {t}_{0} ) + {\int }_{0}^{i} A ( t ) dt \{ \begin{matrix}x ( {t}_{i} ) = x ( {t}_{0} ) + {\sum }_{1}^{{t}_{i}} sx ( t ) \\ y ( {t}_{i} ) = y ( {t}_{0} ) + {\sum }_{1}^{{t}_{i}} sy ( t ) \\ z ( {t}_{i} ) = z ( {t}_{0} ) + {\sum }_{1}^{{t}_{i}} sz ( t )\end{matrix}$$

In the equation above, S corresponds to a speed or velocity at an initial time t₀ and a subsequent times t₁. A corresponds to the linear movement data Axn, Ayn, and Azn for each respective axis. In other words, velocity is an integral of acceleration over time. Once velocity is determined, the distance along each of the x, y, and z axes is a sum of the velocity in the respective axis.

During the time between Position 1 and Position 2, the distance engine 930 may also record angular movement data to determine how an orientation of the client device 100 has changed. Alternatively, since orientation can be determined from a single measurement, the distance engine 930 may only record the angular movement data at Position 2.

Once the user has reached Position 2, the distance engine 930 receives one or more messages from the application 308 indicative that another direct measurement (to Point 2) is to be performed. The distance engine 930 transmits an instruction to the laser distance measurer 304 to perform another distance measurement. The distance engine 930 then receives one or more messages from the laser distance measurer 304 after a direct distance to Point 2 of the object 700 is determined (shown in FIG. 10 as D2). The distance engine 930 also stores the angular movement data from the gyroscopes 306b to the file 1100 in the same row (i.e., Gx2, Gy2, Gz2).

The following disclosure below provides some examples regarding how the indirect distance is determined based on the direct distances D1 and D2 and the movement data. As shown in FIG. 10, the example distance engine 930 is configured to use one or more algorithms to compensate for user movement between Position 1 and Position 2 and/or adjust for inaccuracies introduced from the user. For instance, FIG. 10 shows that Point 2 is not vertically aligned with Point 1. Instead, the user pointed the laser distance device 300 slightly downward to measure the distance to Point 2. In addition, the user moved the laser distance device 300 slightly further away from the object 700 and to the left. The routines, calculations, and/or algorithms described below are configured to correct for user movement so as to determine indirect distance D3 between Point 1 and an adjusted Point 2, which is compensated for linear and unintended angular movement.

### Indirect Distance Calculation Embodiment 1

In a first embodiment, the distance engine 930 is configured to determine the indirect distance D3 by calculating three-dimensional (or two-dimensional) coordinates for Point 1 and an adjusted Point 2 (as illustrated by the hashed circle in FIG. 10). In this example, the distance engine 930 receives the direct distance D1 to Point 1 and the direct distance to Point 2 from the laser distance measurer 304. The distance engine 930 also determines, from the angular movement data, a yaw value at Position 1 (i.e., GO, a pitch value at Position 1 (i.e., Gy₁), and a roll value at Position 1 (i.e., Gz₁) in addition to a yaw value at Position 2 (i.e., Gx₂), a pitch value at Position 2 (i.e., Gy₂), and a roll value at Position 2 (i.e., Gz₂). The distance engine 930 determines, for each position, an Euler angle based on the angular movement data to determine which quadrant the client device 100 is orientated within. As provided below, the quadrant dictates which equations are used. It should be appreciated that the yaw data is indicative of an angle y (shown on FIG. 10) between Point 1 and Point 2 with respect to the laser distance device 300.

In this example, the distance engine 930 is configured to calculate the distance between Point 1 and Point 2 by determining a three-dimensional coordinate (a₁, b₁, c₁) for Point 1 and a three-dimensional coordinate (a₂, b₂, c₂) for Point 2 based on the angular movement data. As shown in FIG. 10, a is along the x-axis, b is along the y-axis and c is along the z-axis. It should be appreciated that no vertical correction is provided for Point 2. Such a configuration enables a user to determine, for example, an indirect distance between two points along a diagonal line. The distance engine 930 uses, for example, the equations below to determine the three-dimensional coordinates of Point 1 (a₁, b₁, c₁) and Point 2 (a₂, b₂, c₂)):
If Position 1 is in the first quadrant

a₁=sin(−Gx₁)*D1*cos(Gy₁)

b₁=cos(−Gx₁)*D1*cos(Gy₁)

c₁=sin(Gy₁)*D1
If Position 2 is in the first quadrant

a₂=sin(−Gx₂)*D2*cos(Gy₂)

b₂=cos(−Gx₂)*D2*cos(Gy₂)

c₂=sin(Gy₂)*D2
If Position 1 is in the second quadrant

a₁=−sin(Gx₁)*D1*cos(Gy₁)

b₁=cos(Gx₁)*D1*cos(Gy₁)

c₁=sin(Gy₁)*D1
If Position 2 is in the second quadrant

a₂=−sin(Gx₂)*D2*cos(Gy₂)

b₂=cos(Gx₂)*D2*cos(Gy₂)

c₂=sin(Gy₂)*D2
If Position 1 is in the third quadrant

a₁=−sin(π−Gx₁)*D1*cos(Gy₁)

b₁=cos(π−Gx₁)*D1*cos(Gy₁)

c₁=sin(Gy₁)*D1
If Position 2 is in the third quadrant

a₂=−sin(π−Gx₂)*D2*cos(Gy₂)

b₂=cos(π−Gx₂)*D2*cos(Gy₂)

c₂=sin(Gy₂)*D2
If Position 1 is in the fourth quadrant

a₁=sin(π+Gx₁)*D1*cos(Gy₁)

b₁=−cos(π+Gx₁)*D1*cos(Gy₁)

c₁=sin(Gy₁)*D1
If Position 2 is in the fourth quadrant

a₂=sin(π+Gx₂)*D2*cos(Gy₂)

b₂=−cos(π+Gx₂)*D2*cos(Gy₂)

c₂=sin(Gy₂)*D2

The distance engine 930 then determines D3 based on square root of a sum of a square between the differences of the respective coordinates of Point 1 and the adjusted Point 2. For instance, the distance engine 930 may use the equation below to determine the indirect distance D3.

D3=\sqrt{(a₁−b₁)²+(b₁−b₂)²+(c₁−c₂)²}

The example distance engine 930 is configured to store the indirect distance D3 to a project file. The distance engine 930 may also store the direct distances D1 and D2 in addition to the coordinates for Point 1 and adjusted Point 2 and/or the movement data. The distance engine 930 is also configured to display the distances D1, D2, and/or D3 within a user interface provided by the application 308.

### Indirect Distance Calculation Embodiment 2

This embodiment is similar to Embodiment 1 except vertical correction is applied to Point 2. For instance, a user may be attempting to measure the distance along a straight line. However, while moving to Position 2, the user may have unintentionally tilted the laser distance device 300 upward or downward slightly. FIG. 10 shows an example where Point 2 is not vertically aligned with Point 1. In some examples, the application 308 may provide a user an option to select whether vertical correction is to be applied.

If vertical alignment is selected, the example distance engine 930 is configured to adjust Point 2 to be vertically aligned with Point 1, as shown by the hashed-circle in FIG. 10. To make the adjustment, the distance engine 930 determines the three-dimensional coordinates of Point 1 (a₁, b₁, c₁) and Point 2 (a₂, b₂, c₂), as described above in Embodiment 1. The distance engine 930 then determines a difference between the pitch angular movement data at Position 1 and Position 2 (e.g., a difference between Gy₁ and Gy₂). The difference is an angle at which the laser distance device 300 was tiled up or down. A ratio of the angle to the distance D2 is used to adjust coordinate b₂ along the y-axis such that an adjusted Point 2 is vertically aligned with Point 1.

In other examples, since it is given that for vertical alignment, b₁ must equal b₂, the three-dimensional coordinates of Point 2 are adjusted by changing b₂ to the value of b₁. The distance D3 is then determined using the equation above in Embodiment 1 incorporating the adjusted value of b₂.

### Indirect Distance Calculation Embodiment 3

The examples discussed in conjunction with Embodiment 1 and Embodiment 2 may be more accurate when Position 1 and Position 2 are laterally close. However, in some instances, there may be a relatively large distance between Position 1 and Position 2. In these examples, the distance engine 930 is configured to adjust the value of D3 based on the difference between Position 1 and Position 2. As discussed above, the a and b coordinates for Point 2 are based on the yaw angle and distance D2. However, the coordinates do not take into account linear movement between Position 1 and Position 2. Further, the equation for D3 above does not take into account linear movement.

To account for linear movement, the distance engine 930 uses the linear movement data from the accelerometers. In some examples, the distance engine 930 uses the linear movement data to determine a net-movement in each direction. For example, the distance engine 930 analyzes all movement along the x-axis to calculate a net-movement along the x-axis (to account for back-tracking). The distance engine 930 then adds (or subtracts based on the relationship to Point 1) the net-linear movement along the x-axis to the three-dimensional coordinate a₂. Similarly, the distance engine 930 adds (or subtracts) net-linear movement along the y-axis to the coordinate b₂ and net-linear movement along the z-axis to coordinate c₂. The result is a correction of the three-dimensional coordinates of Point 2 to compensate for linear movement of the laser distance device 300.

The distance engine 930 then applies vertical alignment correction as discussed in conjunction with Embodiment 2. In some instances, the vertical alignment compensation for angular movement may occur before the linear movement calculation and compensation. The distance D3 is then determined using the equation discussed above in Embodiment 1 using the adjusted values of a₂, b₂, and c₂.

### Indirect Distance Calculation Embodiment 4

In this example embodiment, the distance engine 930 determines a value of D3 as provided in Embodiment 1 or Embodiment 2. Additionally, the distance engine 930 adjusts the value of the indirect distance D3 to compensate for linear movement between Position 1 and Position 2. For instance, the distance engine 930 may calculate a distance D4 between Position 1 and Position 2 from the linear movement data. This may include determining the straight line distance D4 between Position 1 and Position 2 by calculating a path of travel (as provided by the linear movement data). The distance engine 930 adjusts the distance of D3 based on the distance D4. For instance, determining D4 includes 4 inches of movement along the x-axis may cause the distance engine 930 to subtract 4 inches from D3. In another example determining distance D4 includes 3 inches of movement along the y-axis may cause the distance engine 930 to subtract a distance from D3 that is proportional to a ratio of the 3 inches to the Distance D2.

### Indirect Distance Calculation Embodiment 5

In another example, the distance engine 930 is configured to determine the indirect distance D3 using the angle y between the laser distance device 300 to Point 1 and Point 2. Similar to the methods described above, the distance engine 930 determines the direct distance D1 and the angular movement data at Position 1 (i.e., Gx₁, Gy₁, Gz₁). The distance engine 930 also records linear movement data between Position 1 and Position 2 (i.e., Axₙ, Ayₙ, Azₙ) and records the angular movement data at Position 2 (i.e., Gx₂, Gy₂, Gz₂) in addition to the distance D2. The distance engine 930 uses the linear movement data to determine distance D4. Further, the distance engine 930 determines a change in orientation of the laser distance device between Position 1 and Position 2, which is a difference between (Gx₁, Gy₁, Gz₁) and (Gx₂, Gy₂, Gz₂). The distance engine 930 uses the difference in orientation to determine the angle y. The distance processor 930 then uses the angle y in conjunction with distance D4 and distance D2 to determine distance D5. In other words, the distance processor 930 uses movement information regarding how the laser distance device 300 has moved between Position 1 and Position 2 as a basis for correcting distance D2, which is shown as distance D5. In other instances, the distances D2 and D4 alone may be sufficient to determine distance D5. For instance, D2 may be scaled proportionally based on changes in position along the x, y, and z axes using one or more triangulation calculations.

After distance D5 and angle y are determined, the example distance engine 930 is configured to perform a trigonometric function to determine distance D3. For instance, distances D1 and D5 are legs of a triangle where angle y is known. Accordingly, D3 may be determined using the law of cosines equation below:

D3=\sqrt{D1²+D5²−2*D1*D5*cos(y)}

The example distance engine 930 is configured to store the indirect distance D3 to a project file. The distance engine 930 may also store the direct distances D1 and D2 (and/or determined distance D5) in addition to the angle y and/or the movement data. The distance engine 930 is also configured to display some of all of the distances D1 to D5 within a user interface provided by the application 308.

### Indirect Distance Calculation Embodiment 6

In yet another example, the distance engine 930 is configured to determine the indirect distance D3 using an orientation and position of the laser distance device 300 at Position 1 and Position 2. Similar to the methods described above, the distance engine 930 determines the direct distance D1 and the angular movement data at Position 1 (i.e., Gx₁, Gy₁, Gz₁). The distance engine 930 also records linear movement data between Position 1 and Position 2 (i.e., Axₙ, Ayₙ, Azₙ) and records the angular movement data at Position 2 (i.e., Gx₂, Gy₂, Gz₂) in addition to the distance D2. The distance engine 930 determines a change in orientation of the laser distance device between Position 1 and Position 2, which is a difference between (Gx₁, Gy₁, Gz₁) and (Gx₂, Gy₂, Gz₂). The distance processor 930 determines the angle y based on the difference in orientation, especially in the yaw-axis. Further, the distance processor 930 uses the linear movement data to determine distance D4.

The distance engine 930 then determines distance D5, as described above in Embodiment 5. The distance engine 930 then determines a three-dimensional coordinate (a₁, b₁, c₁) for Point 1 and a three-dimensional coordinate (a₂, b₂, c₂) for Point 2 using the equations described in Embodiment 1. However, in these equations, distance D2 is replaced with distance D5, which provides the linear movement compensation. The distance processor 930 then uses the equation from Embodiment 1 for determining the indirect distance D3.

### II. Application Embodiments

As discussed above, the example distance engine 930 may be part of the application 308 operating on the client device 100. For instance, the application 308 may include one or more instructions, that when executed, cause a microprocessor on the client device 100 to perform the methods, routines, or algorithms described above in conjunction with the distance engine 930. In addition to determining the indirect distance D3, the example application 308 is configured to provide other features specified by one or more instructions.

### Project Management Embodiment

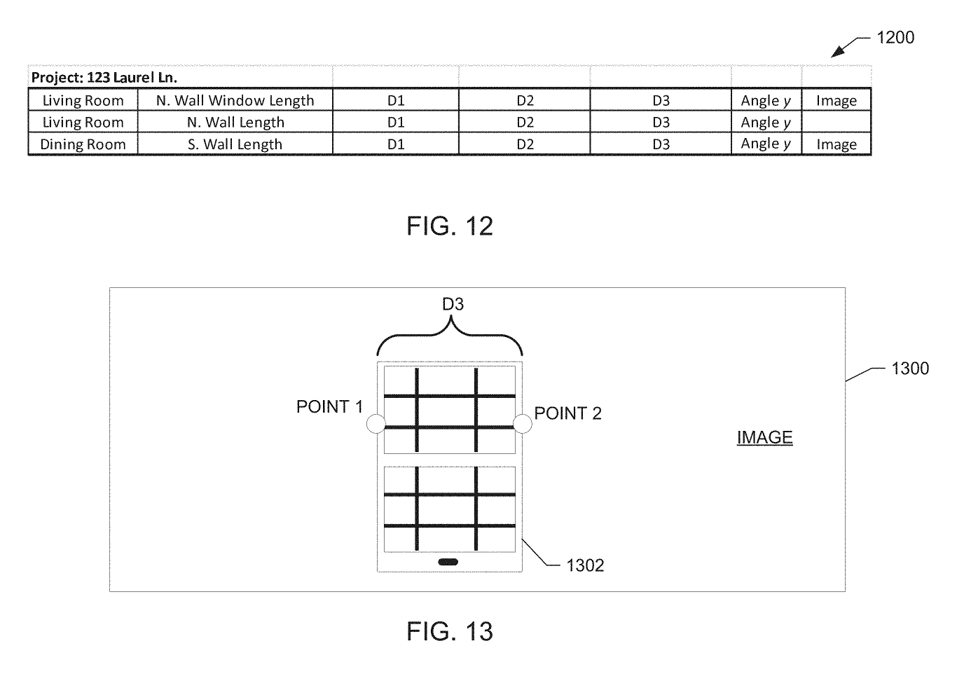

For example, the application 308 may include a project manager 932 configured to manage the storage of measurement data. FIG. 12 shows a diagram of an example project file 1200 that includes distance measurements for a project, according to an example embodiment of the present disclosure. The project manager 932 is communicatively coupled to a memory 934 that is configured to store the project file 1200 in addition to other project files. The memory 934 may include, for example, an Azure SQL database where each entry includes structured data, links, HTML code, and/or XML code. The memory 934 may include any volatile or non-volatile memory including EEPROM, RAM, ROM, SSD, etc.

At the start of a project or session, the project manager 932 may cause the application 308 to prompt a user for project information. This may include a stylesheet or form with one or more fields for a project name, project location, project address, project nickname, owner name, user name, etc. After receiving the project information, the project manager 932 creates, for example, the project file 1200. As shown in FIG. 12, the project information includes the address ‘123 Laurel Ln.’. The project manager 932 is configured to organize measurement data by room or construction area. Accordingly, the project manager 932 causes the application 308 to display a field prompting a user for a room name or description. Measurements recorded within the same room may be grouped together to make it easier for a rendering of a room layout to be created. FIG. 12 shows that the project file includes ‘Living Room’ and ‘Dining Room’ in a room field.

For each measurement, the example project manager 932 is configured to cause the application 308 to prompt a user for a description of a measurement. The description information provides a reminder to the user about which measurement was performed. In some instances, the description may include GPS coordinates received from a GPS processor of the client device 100. As shown in FIG. 12, the description information includes information related to the measurement, such as a length of a window on a north wall of the living room.

After a measurement is preformed, the project manager 932 receives the distance data from the distance engine 930. The distance data includes, for example, the direct distance D1 to Point 1, the direct distance D2 to Point 2 (or as adjusted), and the indirect distance D3 between Point 1 and Point 2. In some examples, the distance data may also include the three-dimensional coordinates of Point 1 (a₁, b₁, c₁) and Point 2 (a₂, b₂, c₂). The distance data may also include the angle y, corresponding to the change in yaw of the laser distance device between Position 1 and Position 2.

In some examples, the project manager 932 may receive an image from an image processor 936 that is related to the distance measurements. The project manager 932 may store a link to the image within the project file 1200 or embed the image itself within the file. As discussed in more detail below, the image shows the object being measured and may show or graphically indicate Point 1 and Point 2. Inclusion of the image within the project file 932 may further make it easier to create a room layout.

While the above is discussed in determining distances between two points, it should be appreciated that the project manager 932 and the distance engine 930 may be configured to determine distances or areas between multiple points. For example, the project manager 932 may cause the application to display a field that enables a user to select a type of measurement to be performed (e.g., distance between two points, distance between n-number of points, an area between n-number of points, or a volume between n-number of points). Based on the selection, the project manager 932 structures the project file accordingly. Further, the distance engine 930 selects the related method, routine, and/or algorithm to correct the appropriate parameter. Further, the application 308 provides the appropriate instructions for obtaining enough direct measurements to complete the indirect calculation.

For example, selection of a calculation for an area of a rectangle causes the application 308 to prompt the user to perform four direct measurements. The distance engine 930 determines indirect distances between each of the four points using any one of the methods described above. The distance engine 930 also determines an area of the rectangle based on the indirect distances between the points.

### Image Inclusion Embodiment

The example image processor 936 of FIG. 9 is configured to relate one or more images to distances determined by the distance engine 930. The image processor 936 is configured to receive the one or more images from the camera 916 of the laser distance measurer 304. In other examples, the images may be received from a camera internal or communicatively coupled to the client device 100. As discussed above, the images are recorded at about the same time the direct distances to Point 1 and Point 2 are determined.

In some instances, the images may include the laser beam reflecting off of the object. In these instances, the image processor 936 is configured to determine a two-dimensional coordinate of the laser incident point relative to an origin at a corner (or center) of the image. For instance, the image processor 936 may use shading and pixel comparisons to identify the light incident point in the image. The image processor 936 then determines a two-dimensional coordinate for the point and stores the coordinates to metadata or information related to the image. The image processor 936 may also receive the direct distance to the point from, for example, the distance engine 930. The image processor 936 is configured to associate the direct distance (and any related indirect distance) with the point for storage to the project file by the project manager 932.

In some instances, the image processor 936 may generate alpha-numeric data to add visually to the image. For example, the image processor 936 may graphically label the light incident point as “Point 1” and include the direct distance D1 for display. The image processor 936 may also access the project file 1200 to add the project name, room location, and/or description to the image. The image processor 936 may also display indirect distance D3 in proximity to the light incident point.

The example image processor 936 may also be configured to determine and display both incident points within an image. As mentioned above, an image may be recorded for each direct distance measurement. In these instances, the image processor 936 is configured to combine the images such that both laser incident points are within a single image. The image processor 936 may draw lines around features within each image (e.g., a window) and compare dimensions of the lines to determine where the images overlap. The image processor 936 may also determine relative distances (with respect to the coordinates of the image itself) from the laser incident points. The image processor 936 then selects one of the images (or combines the images) and includes the coordinates for each of the laser incident points relative to the features within the image. The image processor 936 may also label each point respective as Point 1 and Point 2 based on which image the laser incident point was included within. The image processor 936 may further visually include the indirect distance D3 between the two points. Moreover, the image processor 936 may visually include the direct distances D1 and D2 to the respective points.

FIG. 13 shows a diagram of an example image 1300 created by the image processor 936, according to an example embodiment of the present disclosure. The image 1300 includes a photograph of a wall that includes a window 1302. The image 1300 also includes a visual indication of Point 1 and a visual indication of Point 2. Further, the image 1300 includes a visual indication of the distance D3 between Point 1 and Point 2, as determined by the distance engine 930.

In some embodiments, the image processor 936 may relate multiple distances to an image. For example, the image processor 936 may determine from the project file 1200 that a length and width of the window 1302 were measured. The image processor 936 accordingly determines the images related to each of the direct measurements, identifies common features in each image, and determines laser incident points for display in a single image. The image processor 936 then determines from the distance engine 930 the indirect distances and the corresponding points within the image.

After creating or processing an image, the example image processor 936 is configured to transmit the image to the project manager 932. The example project manager 932 may store the image directly to the project file 1200 within the memory 934. Alternatively, the project manager 932 may store the image to the memory 934 and store a link to a memory location of the image to the project file 1200.

### Application Interface Embodiment

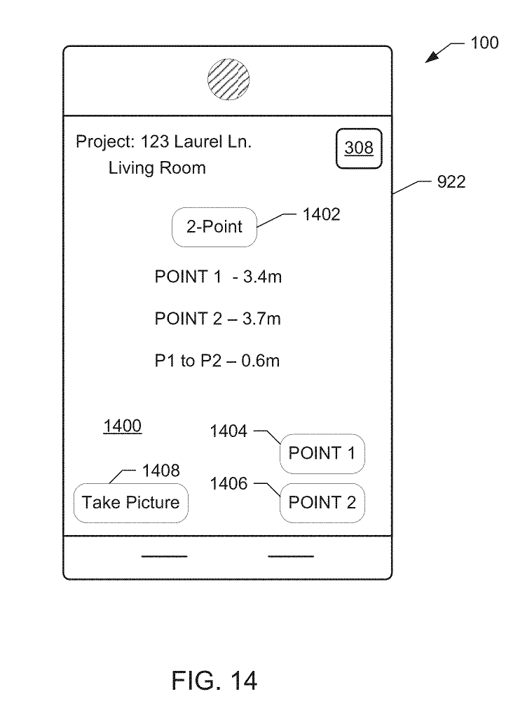

The example client device 100 of FIG. 9 includes an application interface 938 configured to manage a user interface for displaying distance data within the application 308. FIG. 14 shows a diagram of an example user interface 1400 of the application 308 provided by the application interface 938, according to an example embodiment of the present disclosure. The user interface 1400 is shown to the user via the display 922 of the client device 100. The application interface 938 is configured to provide forms with fields prompting a user for information. For instance, the user interface 1400 includes fields for a project name, shown as ‘Project: 123 Laurel Ln.” and room name, shown as “Living Room”. A user may select either of these fields to update the information in the project file 1200 of FIG. 12. The application interface 938 is configured to receive an entry of information into the fields and update the project file 1200 accordingly.

The example application interface 938 is also configured to enable a user to specify which type of measurement is to be determined. For instance, the user interface 1400 includes button 1402, which may include a drop-down menu provided by the application interface 938 of possible measurements that are supported or may be performed. Selection of a measurement causes the application interface 938 to display a number or the types of direct measurements needed to perform the indirect distance or area calculation. For instance, responsive to selecting the 2-Point measurement option, the application interface 938 causes the user interface 1400 to display an option to record a direct measurement for Point 1 (i.e., button 1404) and a direct measurement for Point 2 (e.g., button 1406). Selection of the button 1404 is detected by the application interface 938, which transmits one or more messages to the laser distance measurer 304 to perform a direct distance measurement. Similarly, selection of the button 1406 causes the application interface 938 to transmit one or more messages to the laser distance measurer 304 to perform a direct distance measurement for the second point. In some instances, the application interface 938 may also provide instructions (text or graphical) that describe how the measurement is to be performed.

As discussed above, one or more images may be recorded in conjunction with the direct distance measurements. However, in some instances, a user may record images separate from the distance measurements. The example application interface 938 provides a picture button 1408 within the user interface 1400 to enable a user to record an image within the application 308 without having to access a camera application. In these instances, the image processor 936 is configured to store the recorded image to the project file 1200 to an entry with a similar project name or room description. In other instances, the recorded images are generally stored to the project file 1200 and include the room description specified in the fields of the user interface 1400 at the time the instruction to record the image was received. The room description may be stored to metadata of the respective image file.

The application interface 938 is further configured to display the distance data within the user interface 1400. In the example of FIG. 14, the application interface 938 causes the direct distance to Point 1 and the direct distance to Point 2 to be displayed in conjunction with the indirectly determined distance between Point 1 and Point 2. In other examples, the application interface 938 may also display the three-dimensional coordinates for Point 1 and Point 2, the angle y, or any of the angular movement data or linear movement data. In some embodiments, the application interface 938 may provide a feature that enables a user to specify whether the displayed data is to be stored. Data that is indicated to be deleted is removed from the project file 1200. In some instances, the application interface 1200 may only display data that is stored to the project file 1200.

In some embodiments, the user interface 1400 may also display angular movement data and/or linear movement data. For instance, the distance engine 930 may transmit the movement data to the application interface 938, which formats or converts the data into unit values for display such that a user can view 6 DoF movement data as the laser distance device 300 is being used. Such information may visualize the user's movements, thereby helping the user to reduce movement of the device 300 between the measurement positions. The 6 DoF movement data may also be used to provide a 2-axis level, which may be graphically displayed within the user interface 1400.

Further, in some instances, the application 308 may include instructions that prevent a distance to a point from being taken until the movement data is below a threshold. For instance, the application interface 938 may not transmit instructions to the laser distance measurer 304 to perform a direct distance measurement as long as any linear movement data is greater than ±0.25 g and/or the angular acceleration data is greater than ±0.5°/s. In other instances, the application interface 938 may enable distance measurements to be taken regardless of user movement as long as movement data is recorded to enable compensation of the movement. Moreover, the user interface 1400 operating in conjunction with the application 308 may enable a user to select whether vertical correction (or horizontal correction) is to be applied in instances where a user is attempting to measure a distance between vertically (or horizontally) aligned points.

### Dock State Detection Embodiment

As mentioned above, the example client device 100 is configured to detect when the laser distance measurer 304 is disconnected. To detect whether the laser distance measurer 304 is docked, the client device 100 includes a dock processor 940. The example dock processor 940 may include instructions as part of the application 308 that are configured, when executed, to determine when the laser distance measurer 304 or the case 302 is removed from the client device 100. The example dock processor 940 is configured to compare angular movement data from the motion sensors 914 of the measurer 304 to angular movement data from the gyroscopes 306b of the client device 100. A difference in the data is indicative that the client device 100 is orientated in a different position than the measurer 304 and that the devices are mostly likely not connected together. The dock processor 940 may also analyze the linear movement data from the accelerometers 306a to further verify that the client device 100 is no longer being held steady, indicative that the client device 100 is being used for other purposes.

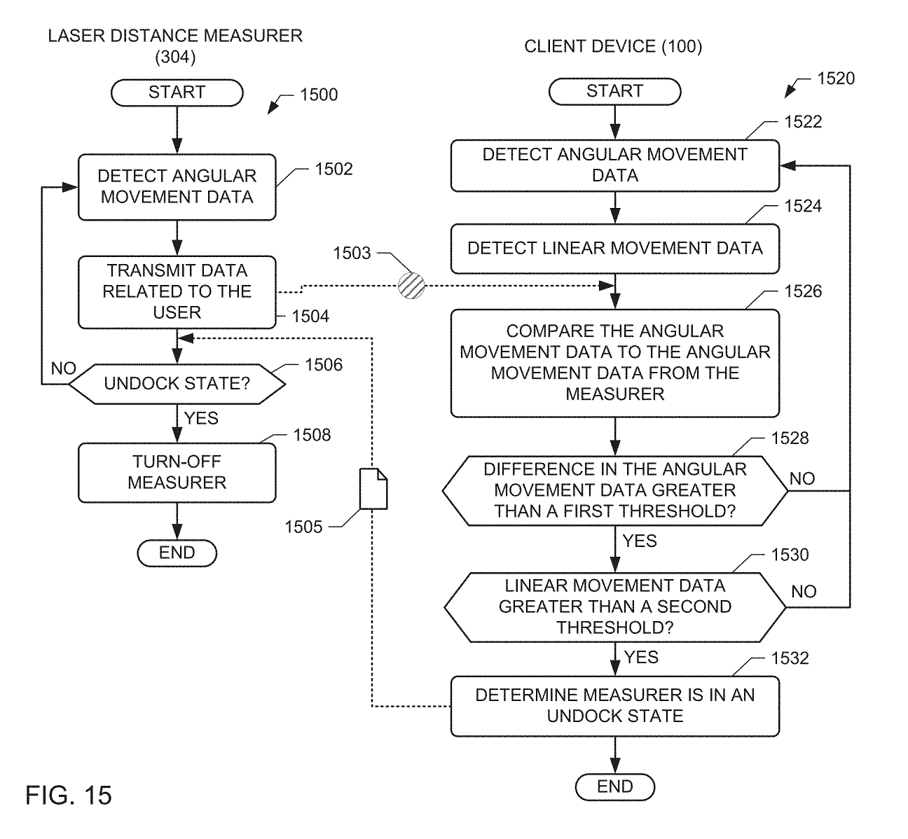

FIG. 15 illustrates flow diagrams showing example procedures 1500 and 1520 to determine a dock state of the laser distance measurer 304, according to example embodiments of the present disclosure. Although the procedures 1500 and 1520 are described with reference to the flow diagrams illustrated in FIG. 15, it should be appreciated that many other methods of performing the steps associated with the procedures 1500 and 1520 may be used. For example, the order of many of the blocks may be changed, certain blocks may be combined with other blocks, and many of the blocks described are optional. Further, the actions described in procedures 1500 and 1520 may be performed among multiple devices including, for example the laser distance measurer 304 and/or the client device 100.

The example procedure 1500 of FIG. 15 begins when the motion sensors 914 detect angular movement data (block 1502). The movement data may include at least one of roll, pitch, and/or yaw movement (or position) data 1503. The laser distance measurer 304 then transmits the movement or position data 1503 to the client device 100 (block 1504). The laser distance measurer 304 then determines if dock state information within a message 1505 has been received (block 1506). If no dock state information is received or the information is indicative that the laser distance measurer 304 is docked, the procedure 1500 returns to block 1502 to record additional angular movement data. However, if the information in the message 1505 is indicative that the laser distance measurer 304 is undocked (but still within communication range), the laser distance measurer 304 powers off (block 1508), thereby conserving power. In other examples, the laser distance measurer 304 may stop sending data (e.g., distance data, images, angular movement data) to the client device 100. The example procedure 1500 then ends.

The example procedure 1520 of FIG. 15 begins when the dock processor 940 of the client device 100 receives or detects angular movement (or position) data from the gyroscope 306b (block 1522). The client device 100 also receives or detects linear movement data from the accelerometers 306a (block 1524). The dock processor 940 then compares the angular movement data from the laser distance measurer 304 to the angular movement data from the gyroscopes 306b (block 1526). For instance, the dock processor 940 may compare individual yaw, pitch, and roll values and calculate differences. Any difference that is less than a threshold (such as 5%, 10%, or 20%) is determined to be a match to account for sensor error. Any difference that is greater than a threshold is determined to be a difference. If enough differences occur within a time period (e.g., one second, two seconds, five seconds, etc.) such that the number of differences, as percentage total comparisons, exceed a threshold (e.g., 50%, 60%, 70%, 80%, 90%, or 95%), then the dock processor 940 determines there is a difference in the movement data (block 1528). If the number of differences does not exceed a threshold, the dock processor 940 determines there is no difference in the angular movement data and returns to block 1522 to detect different angular movement data for another time period.

However, if there are enough differences in block 1528, the dock processor 940 proceeds to block 1530 to determine if the linear movement data is greater than another threshold. For example, linear movement data in any axis that is greater than 0.5 g may be indicative that the laser distance measurer 304 is undocked from the client device 100. If the threshold is satisfied, the dock processor 1505 determiners the laser distance measurer 304 is in an undock state and may transmit one or more dock information messages 1505 indicative of the undock state (block 1532). In some instances, the block 1530 may be omitted such that the dock state is determined solely based on the angular movement data.

In addition to or alternative from transmitting the message 1505, the example dock processor 940 may cause the application 308 to disable the distance engine 930, cause an alert message indicative of the undock to be displayed within the user interface 1400 of FIG. 14, instruct the laser distance measurer 304 to power off, terminate communication with the measurer 304, and/or disregard distance measurement data from the measurer 304. Further, the application 308 may close after detecting a disconnection of the laser distance measurer 304. The example procedure 1520 may then end.

### Distance Measurement Procedure Embodiment

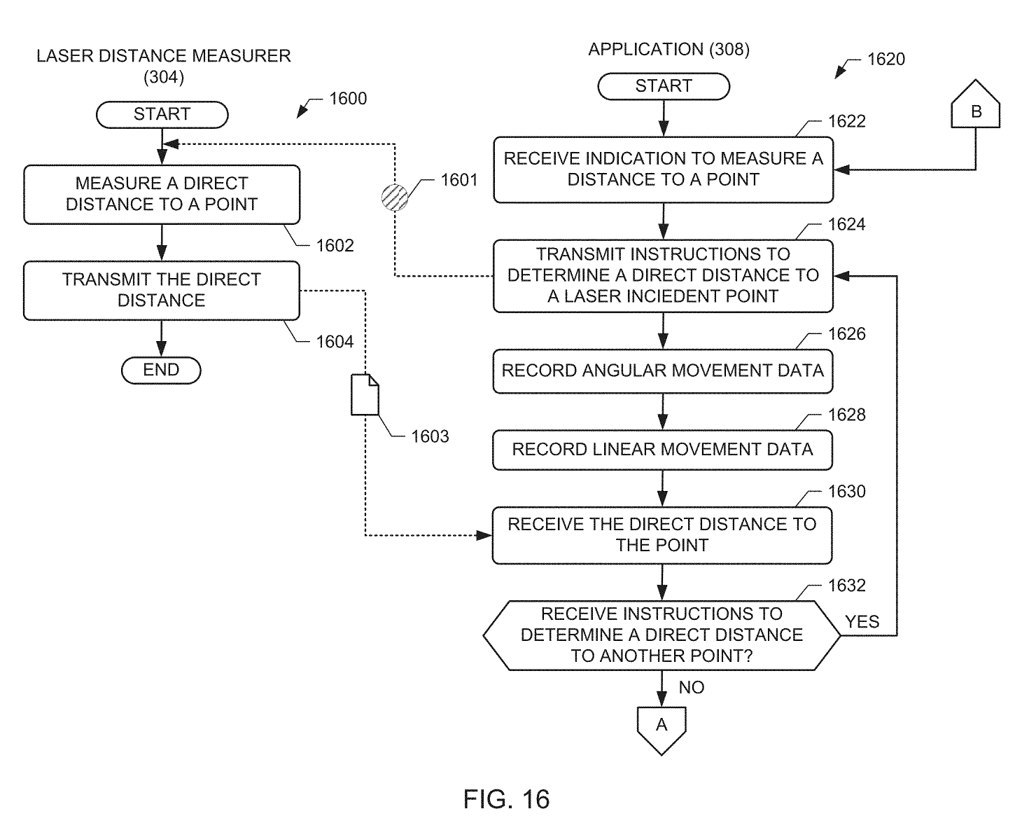

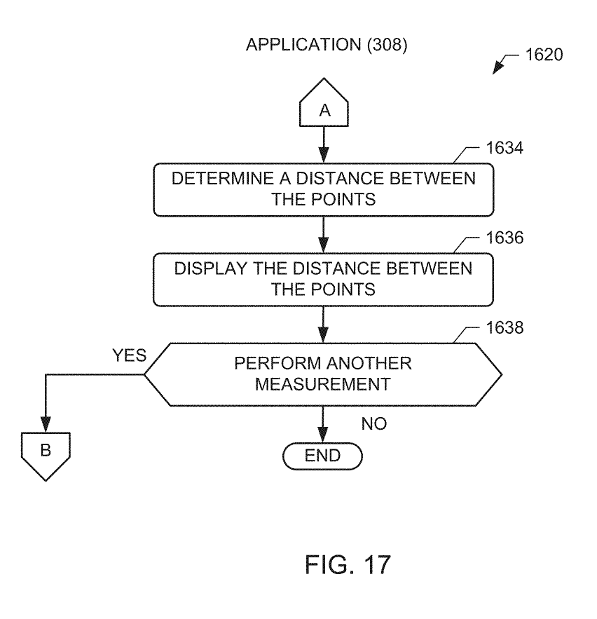

FIGS. 16 and 17 illustrate flow diagrams showing example procedures 1600 and 1620 to determine an indirect distance between two remote points, according to example embodiments of the present disclosure. Although the procedures 1600 and 1620 are described with reference to the flow diagrams illustrated in FIGS. 16 and 17, it should be appreciated that many other methods of performing the steps associated with the procedures 1600 and 1620 may be used. For example, the order of many of the blocks may be changed, certain blocks may be combined with other blocks, and many of the blocks described are optional. Further, the actions described in procedures 1600 and 1620 may be performed among multiple devices including, for example the laser distance measurer 304 and/or the client device 100.

The example procedure 1600 begins when the laser distance measurer 304 receives at least one message 1601 from the application 308 operating on the client device 100 indicative that a direct measurement is to be performed. After receiving the message, the laser distance measurer 304 measures a direct distance to a point on a remote object using laser light transmitted from the light transmitter 902 (block 1602). After determining the direct distance, the laser distance measurer 304 transmits one or more messages 1603 that are indicative of the direct distance (block 1604). At this point, the example procedure 1600 ends. It should be appreciated that the example procedure 1600 is executed anytime a direct distance to a point is requested by the application 308.

The example procedure 1620 begins when the application 308 operating on the client device 100 receives an indication to measure a direct distance to a point (block 1622). After receiving the indication, the application 308 transmits one or more messages 1601 to the laser distance measurer 304 indicative that a direct distance to a remote point is to be determined (block 1624). The application 308 also records angular movement data (block 1626) and linear movement data (block 1628), which may be stored in the file 1100 of FIG. 11. While recording the data, the application 308 receives a message 1603 indicative of the direct distance (block 1630), which may be stored in the file 1100.

The application 308 then checks whether another direct distance is to be measured (block 1632). If a user provides an indication that another direct distance is to be measured (e.g., via user interface 1400), the application 308 returns to block 1622 to transmit one or more messages 1601 to the laser distance measurer 1600 with instructions to measure a direct distance. In some embodiments, the application 308 may determine another direct distance is needed based on the parameter being measured. For example, the application 308 may determine that another direct distance is needed to determine a distance between two points, or another direct distance is needed to determine a parameter, area, or volume specified by a user. In these instances, the application 308 may cause a prompt to be displayed indicating the remaining direct distances that still need to be determined. In some instances, the prompt may be graphical, such as an outline of a shape or volume to be determined, with already measured distances or areas highlighted in a separate color or pattern.

Returning to block 1632, if no additional direct measurements are needed, the example application 308 determines one or more indirect distances between the measured points (block 1634 of FIG. 17). The application 308 may also determine a parameter, circumference, area, or volume, as requested by the user. The application 308 then displays the determined indirect distance (and/or determined parameter, circumference, area, or volume) related to the direct distance of the measured points (block 1636). In some instances, the application 308 may also display the direct distances and/or coordinates of the direct distances. The application 308 then determines if another measurement is to be performed (block 1638). If another measurement is to be performed, the application 308 returns to block 1622 to begin measuring direct distances to one or more points. For example, additional measurements may be performed for different architectural features, rooms, projects, etc. However, if no additional measurement is to be performed, the example procedure 1620 operating on the application 308 ends.

### CONCLUSION

It will be appreciated that all of the disclosed methods and procedures described herein can be implemented using one or more computer programs or components. These components may be provided as a series of computer instructions on any computer-readable medium, including RAM, ROM, flash memory, magnetic or optical disks, optical memory, or other storage media. The instructions may be configured to be executed by a processor, which when executing the series of computer instructions performs or facilitates the performance of all or part of the disclosed methods and procedures.

It should be understood that various changes and modifications to the example embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An indirect distance measurement apparatus comprising:
a laser device configured to:
emit a laser beam, and
detect a distance to a point at which the laser beam reflects off of an object;
an accelerometer configured to measure linear movement of the apparatus;
a gyroscope configured to measure angular movement of the apparatus; and
a distance processor configured to:
transmit a first message, at a first time, instructing the laser device to perform a first direct distance measurement to determine a first distance to a first point on the object,
receive, at the first time, first angular movement data from the gyroscope,
receive, after the first time and before a second time, linear movement data from the accelerometer,
transmit a second message, at the second time, instructing the laser device to perform a second direct distance measurement to determine a second distance to a second point on the object,
receive, at the second time, second angular movement data from the gyroscope,
determine a distance between the first point and the second point on the object, as an indirect distance measurement, based on (i) the first distance, (ii), the second distance, (iii) the first angular movement data, (iv) the second angular movement data, and (v) the acceleration data, and
transmit the determined distance between the first point and the second point.

2. The indirect distance measurement apparatus of claim 1, wherein the distance processor is configured to determine the distance between the first point and the second point by:
determining a first three-axis coordinate (x1, y1, z1) of the first point based on the first distance and the first angular movement data;
determining a second three-axis coordinate (x2, y2, z2) of the second point based on the second distance and the second angular movement data; and
calculating the determined distance between the first point and the second point as a square root of (x1−x2)̂2+(y1−y2)̂2+(z1−z2)̂2.

3. The indirect distance measurement apparatus of claim 2, wherein the distance processor is configured to determine the distance between the first point and the second point by:
determining a distance traveled by the apparatus between the first point and the second point based on the acceleration data; and
adjusting the calculated distance based on the determined distance traveled.

4. The indirect distance measurement apparatus of claim 2, wherein the distance processor is configured to:
determine whether the first point is in a first quadrant, a second quadrant, a third quadrant, or a fourth quadrant based on a first Euler angle determined from the first angular movement data;
determine the first three-axis coordinate (x1, y1, z1) by also taking into account the determined quadrant of the first point;
determine whether the second point is in a first quadrant, a second quadrant, a third quadrant, or a fourth quadrant based on a second Euler angle determined from the second angular movement data; and
determine the second three-axis coordinate (x2, y2, z2) by also taking into account the determined quadrant of the second point.

5. The indirect distance measurement apparatus of claim 1, wherein the distance processor is configured to determine the distance between the first point and the second point by:
determining an angle y between the first distance and the second distance based on the first angular movement data and the second angular movement data;
determining a distance traveled by the apparatus between the first time and the second time based on the acceleration data;
calculating an approximate distance between the first point and the second point using a triangle calculation where the first distance is a first side of a triangle, the second distance is a second side of the triangle, the angle y is between the first and second sides of the triangle, and the distance approximate between the first point and the second point is a third side of the triangle; and
adjusting the approximate distance using the distance traveled by the apparatus between the first time and the second time.

6. The indirect distance measurement apparatus of claim 1, wherein the accelerometer is configured to measure linear movement along an X-axis, a Y-axis, and a Z-axis.

7. The indirect distance measurement apparatus of claim 1, wherein the gyroscope is configured to measure angular movement as at least one of angular acceleration or angular velocity along a Yaw-direction, a pitch-direction, and a roll-direction.

8. The indirect distance measurement apparatus of claim 1, further comprising a display screen configured to display the determined distance between the first point and the second point.

9. The indirect distance measurement apparatus of claim 1, further comprising a user interface operable with a display configured to:
record a first indication provided by a user to perform the first direct distance measurement at the first time;
record a second indication provided by a user to perform the second direct distance measurement at the second time; and
render for display the determined distance between the first point and the second point.

10. A distance measurement apparatus comprising:
a case including a laser device having:
a light source configured to emit a laser beam, and
a processor configured to determine a distance to a point at which the laser beam reflects off of an object; and
a client device communicatively coupled to the laser device and including:
an accelerometer configured to measure linear movement of the apparatus,
a gyroscope configured to measure angular movement of the apparatus,
a processor configured to:
receive, at a first time from the laser device, a first distance to a first point on the object, and at the second time from the laser device, a second distance to a second point on the object,
determine, at the first time, first angular movement data from the gyroscope and at the second time, second angular movement data from the gyroscope,
determine, between the first time and a second time, linear movement data from the accelerometer, and
determine a distance between the first point and the second point on the object using (i) the first distance, (ii) the second distance, (iii) the first angular movement data, (iv) the second angular movement data, and (v) the acceleration data, and
a display screen configured to display the determined distance between the first point and the second point.

11. The distance measurement apparatus of claim 10, wherein the case is removably connectable to the client device and the laser device is removably connectable to the case.

13. The distance measurement apparatus of claim 11, wherein the laser device includes an angular position sensor and is configured to transmit angular position data to the client device.

14. The distance measurement apparatus of claim 10, wherein the processor is configured to:
compare the angular position data to current angular movement data from the gyroscope; and
conditioned upon a threshold number of values between the angular position data and the angular movement data being different, determine the case is disconnected from the client device.

15. The distance measurement apparatus of claim 14, wherein the processor is configured to, upon determining the case is disconnected, at least one of:
(i) terminate communication between the client device and the laser device;
(ii) instruct the laser device to power off; and
(iii) disregard distance measurement data from the laser device.

16. The distance measurement apparatus of claim 10, wherein the processor is configured to:
compare current linear movement data to a second threshold number; and
determine the case is disconnected from the client device if the current linear movement data is greater than the second threshold number in addition to the threshold number of values between the angular position data and the angular movement data being different.

17. The distance measurement apparatus of claim 10, wherein the client device is communicatively coupled to the laser device via at least one of a Bluetooth® connection and a near-field communication (“NFC”) connection.

18. A distance measurement apparatus communicatively coupled to a laser device configured to detect a distance to a point at which a laser beam reflects off of an object, the apparatus comprising:
an accelerometer configured to measure linear movement of the apparatus;
a gyroscope configured to measure angular movement of the apparatus; and
a processor operating an application including instructions stored in a memory, which when executed, cause the application to:
determine a first three-dimensional orientation of the apparatus at a first time based on first angular movement data from the gyroscope,
determine a second three-dimensional orientation of the apparatus at a second time based on second angular movement data from the gyroscope,
determine a travel distance between the apparatus at the first time and the apparatus at the second time based on linear movement data from the accelerometer,
determine, at the first time from the laser device, a first distance to a first point on the object, and at the second time from the laser device, a second distance to a second point on the object,
determine a distance between the first point and the second point based on the (i) first distance, (ii) the second distance, (iii) the first three-dimensional orientation of the apparatus, (iv) the second three-dimensional orientation of the apparatus, and (v) the travel distance, and
cause the determined distance between the first point and the second point to be displayed within a user interface.

19. The distance measurement apparatus of claim 18, wherein the instructions cause the application to:
determine an angle y between the first point and the second point based on the first three-dimensional orientation of the apparatus and the second three-dimensional orientation of the apparatus; and
determine the distance between the first point and the second point based on the first distance, the second distance, the angle y, and the travel distance.

20. The distance measurement apparatus of claim 17, wherein the instructions cause the application to:
before the first time, create a project file; and
store the determined distance between the first point and the second point to the project file.

21. The distance measurement apparatus of claim 20, further comprising a camera configured to record an image of the object,
wherein the instructions cause the application to relate the image to the determined distance between the first point and the second point and store the image to the project file.

22. The distance measurement apparatus of claim 21, wherein the camera is configured to record within the image the laser beam located at the first point, and
the instructions cause the application to:
determine coordinates of the first point within the image, and
relate the first distance to the first point within the image using the determined coordinates.

23. The distance measurement apparatus of claim 21, wherein the instructions cause the application to:
use the determined distance between the first point and the second point to determine coordinates of the second point within the image; and
relate the second distance to the second point within the image using the determined coordinates of the second point.
